(19) United States
(12) Patent Application Publication
(10) Pub. No.: US 2009/0234945 A1
(43) Pub. Date: Sep. 17, 2009

(54) METHOD, APPARATUS AND COMPUTER PROGRAM PRODUCT FOR ACTIVE NODE SELECTION

(76) Inventors: Suresh Balakrishnan Chande, Espoo (FI); Srividya Gopalan, Bangalore (IN); Swetha Kurup, Bangalore (IN)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/388,175

(22) Filed: Feb. 18, 2009

(30) Foreign Application Priority Data
Mar. 14, 2008 (IN) 641/DEL/2008

(51) Int. Cl. G06F 15/173

(52) U.S. Cl. 709/224

(57) ABSTRACT

An apparatus for enabling active node selection may include a distribution potential determiner and a node selector. The distribution potential determiner may be configured to determine a distribution potential for a particular node based on characteristics of the particular node. The distribution potential may be indicative of a relative likelihood of the particular node distributing content received by the particular node. The node selector may be configured to select the particular node as an active node in response to a determination that the distribution potential meets predetermined selection criteria. A method and computer program product for active node selection is also provided.

### CROSS REFERENCE TO RELATED APPLICATIONS

This application claims priority to Indian Application No. 641/DEL/2008, filed Mar. 14, 2008, the contents of which are incorporated herein in their entirety.

### FIELD OF THE INVENTION

Embodiments of the present invention relate generally to the provision of services to electronic devices and, more particularly, relate to an apparatus, method and a computer program product for providing services such as advertisements, coupons or other targeted communications to certain selected active nodes.

### BACKGROUND OF THE INVENTION

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Such increased ease of information transfer and convenience to users has recently been accompanied by an increased ability to provide mobile communications at a relatively low cost. Accordingly, mobile communication devices are becoming ubiquitous in the modern world. With the rapid expansion of mobile communications technology, there has been a related rapid expansion in those services that are demanded and provided via mobile communication devices.

One area in which services have recently expanded relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, etc., or even from a combination of the mobile terminal and the network device. In this regard, various applications and software have been developed and continue to be developed in order to give the users robust capabilities to perform tasks, communicate, obtain information or services, entertain themselves, etc. in either fixed or mobile environments.

Given the robust capabilities of mobile electronic devices and the relatively small size of such devices, it is becoming increasingly common for individuals to keep mobile electronic devices on or near their person on a nearly continuous basis. Moreover, because such devices are useful for work, play, leisure, entertainment, and other purposes, many users also interact with their devices on a frequent basis. As such, the activity associated with one's electronic device(s) may be indicative of the interests and/or tendencies of the user of the device(s). Marketers and sellers of goods and services have appreciated the potential of utilizing mobile electronic devices to reach the users thereof with advertisements and/or offers in their merchandizing efforts. As such, the provision of merchandise or service related messaging has become increasingly more prevalent. Furthermore, by gathering information about particular individuals, targeted marketing may be accomplished. However, some such mechanisms, like mass email marketing or spamming, may not be appreciated by many recipients.

Accordingly, it may be desirable to develop a mechanism by which to enable the communication of materials with a relatively wide distribution without generating a stigma as may be the case with spam.

### BRIEF SUMMARY OF THE INVENTION

A method, apparatus and computer program product are therefore provided that may enable active node selection. In this regard, for example, embodiments of the present invention may enable the identification of particular nodes (e.g., mobile terminals) that may be more likely to provide effective distribution of materials to other nodes. The particular nodes may be designated as active nodes to which materials may be provided.

In the context of content sharing, certain content items (e.g., videos, music, etc.) may be spread through networks such as the Internet with such speed that they are almost virus like in their propagation. Accordingly, such content items may be referred to as being “viral”. Viral content typically gets transferred, or at least interest in such content may get transferred, by word of mouth or by individuals sharing such content directly with others. Advertisers, marketers and the like, would also typically hope to see their ads, coupons, offers, etc. go viral. Embodiments of the present invention may enable the development of a viral network by identifying those individuals that may be likely to be good sources for effective distribution of material and treating those individuals as active nodes. The material may then be provided to the active nodes to distribute to others.

In this regard, mobile electronic devices are also becoming increasingly popular for use in social networking and/or content sharing. As such, for example, a particular individual may be very active in sharing content, ads, coupons or other materials with other individuals. Furthermore, receivers of these various materials may be more likely to receive the materials willingly or even enthusiastically if they are received from a member of their social network or someone they trust. Embodiments of the present invention may enable active nodes to be identified as nodes that are likely to effectively distribute materials, and in some cases, also as nodes that may be likely to receive a positive reaction in response to their distribution efforts. Furthermore, in some instances, the active nodes may be classified or associated with particular types of information, groups of users, etc., so that a desirable target audience may be more likely to be reached. Accordingly, exemplary embodiments of the present invention may enable the classification of particular nodes as active nodes and the mapping of social networks.

In one exemplary embodiment, a method of enabling selection of an active node is provided. The method may include determining a distribution potential for a particular node based on characteristics of the particular node, and selecting the particular node as an active node in response to a determination that the distribution potential meets predetermined selection criteria. The distribution potential may be indicative of a relative likelihood of the particular node distributing content received by the particular node.

In another exemplary embodiment, a computer program product for enabling selection of an active node is provided. The computer program product may include at least one computer-readable storage medium having computer-readable program code portions stored therein. The computer-readable program code portions may include a first executable portion, a second executable portion and a third executable portion. The first executable portion may be for determining a distribution potential for a particular node based on characteristics of the particular node. The second executable portion may be for selecting the particular node as an active node in response to a determination that the distribution potential meets predetermined selection criteria. The distribution potential may be indicative of a relative likelihood of the particular node distributing content received by the particular node.

In another exemplary embodiment, an apparatus for enabling selection of an active node is provided. The apparatus may include a distribution potential determiner and a node selector. The distribution potential determiner may be configured to determine a distribution potential for a particular node based on characteristics of the particular node. The distribution potential may be indicative of a relative likelihood of the particular node distributing content received by the particular node. The node selector may be configured to select the particular node as an active node in response to a determination that the distribution potential meets predetermined selection criteria.

In another exemplary embodiment, an apparatus for enabling selection of an active node is provided. The apparatus includes means for determining a distribution potential for a particular node based on characteristics of the particular node and means for selecting the particular node as an active node in response to a determination that the distribution potential meets predetermined selection criteria. The distribution potential may be indicative of a relative likelihood of the particular node distributing content received by the particular node.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram a portion of a system for viral network distribution according to an exemplary embodiment of the present invention;

FIG. 4 illustrates a block diagram of the architecture of a device for viral network distribution according to an exemplary embodiment of the present invention;

FIG. 5 illustrates a block diagram showing an apparatus for enabling active node selection according to an exemplary embodiment of the present invention;

FIG. 6 illustrates an example of a criteria tree for use in active node selection according to an exemplary embodiment;

FIG. 7 illustrates a network based on workflow roles for a particular node that may be evaluated by a distribution potential determiner according to an exemplary embodiment of the present invention;

FIG. 8 illustrates an exemplary network based on similar interests among various contexts according to an exemplary embodiment of the present invention;

FIG. 9 illustrates an exemplary network based on positive responses received from nodes to which a particular node sent messages or forwarded ads according to an exemplary embodiment of the present invention;

FIG. 10 illustrates an exemplary network based on relationships between nodes according to an exemplary embodiment of the present invention;

FIG. 11 illustrates an example of a relatively comprehensive diagram of a network illustrating different factors that may influence relationships between nodes according to an exemplary embodiment of the present invention;

FIG. 12 is a flowchart according to an exemplary method of enabling active node selection according to an exemplary embodiment of the present invention; and

FIG. 13 is a flowchart according to another exemplary method of enabling active node selection according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

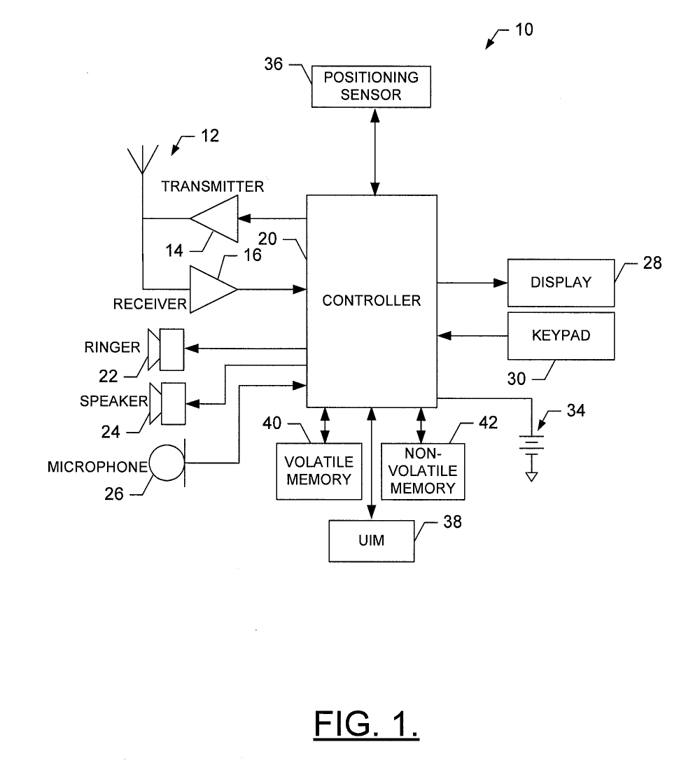

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

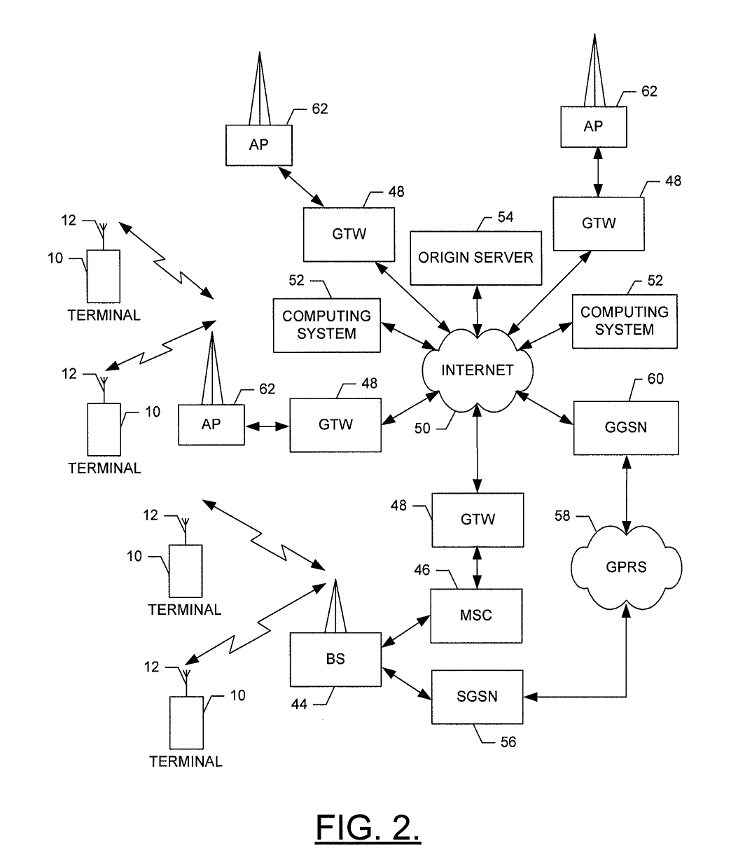

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In addition, the mobile terminal 10 may include a positioning sensor 36. The positioning sensor 36 may include, for example, a global positioning system (GPS) sensor, an assisted global positioning system (Assisted-GPS) sensor, a Bluetooth (BT)-GPS mouse, other GPS or positioning receivers or the like. However, in one exemplary embodiment, the positioning sensor 36 may include a pedometer or inertial sensor. In this regard, the positioning sensor 36 may be capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information. In this regard, for example, the position history may define a series of data points corresponding to positions of the mobile terminal 10 at respective times. Various events or activities of the mobile terminal 10 may also be recorded in association with position history or location information provided by the positioning sensor.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content or information sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a server, personal computer or other device, absent any communication with the system of FIG. 2.

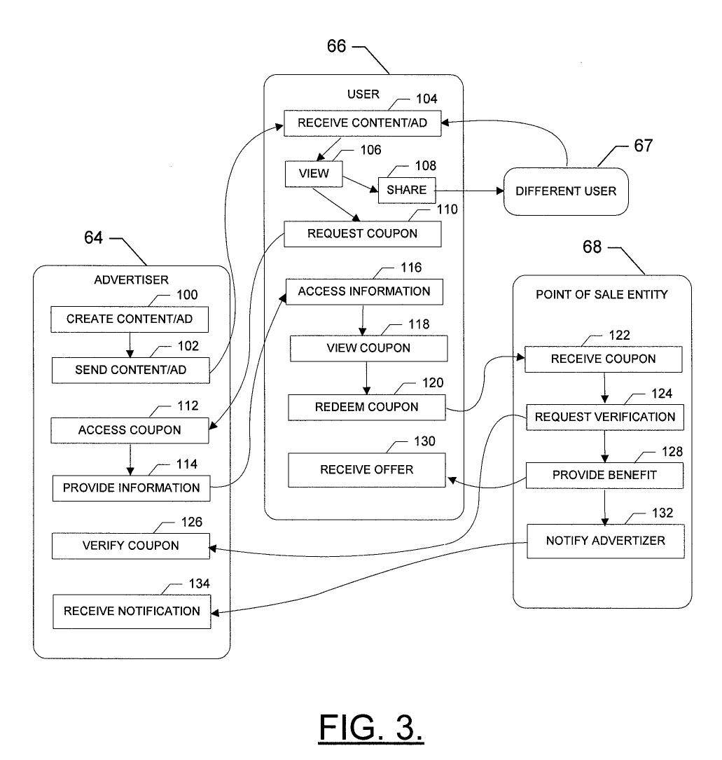

FIG. 3 illustrates a block diagram of a portion of a system for viral network distribution according to an exemplary embodiment of the present invention. In this regard, for example, a system for viral network distribution of material or content such as an advertisement will be described below. However, content other than advertisements, coupons, or the like may also be distributed in accordance with embodiments of the present invention. For example, media content, advisories, news alerts, and/or other content may also be distributed in accordance with embodiments of the present invention.

As indicated above, wide distribution of a particular ad, coupon, content item, etc., may be desired by a marketer or advertiser. Thus, the marketer or advertiser may generate content or materials (e.g., an ad that may be associated with a coupon) for distribution. FIG. 3 shows one example of how such distribution may be accomplished. As shown in FIG. 3, an exemplary architecture for a system for viral network distribution may include various different entities such as an advertiser 64 and one or more users (e.g., user 66 and different user 67). The users may be individuals associated with a particular mobile or fixed electronic device that may serve as a communication terminal (e.g., the mobile terminal 10 or a personal computer (PC)) by which the users may interface with each other or network entities such as the advertiser 64 (e.g., via the system of FIG. 2). In some embodiments, the users may communicate with a point of sale entity 68 to redeem a coupon or respond to an ad in order to complete a transaction to acquire a particular good or service associated with the ad or coupon. Each of the users 66 and 67, the advertiser 64 and the point of sale entity 68 in this exemplary embodiment may be associated with a corresponding electronic device (e.g., a mobile terminal, PC, server, etc.). As such, although communications below are described as passing between the entities above, it should be understood that such communications may actually be passing between the corresponding electronic devices associated with each of the respective entities.

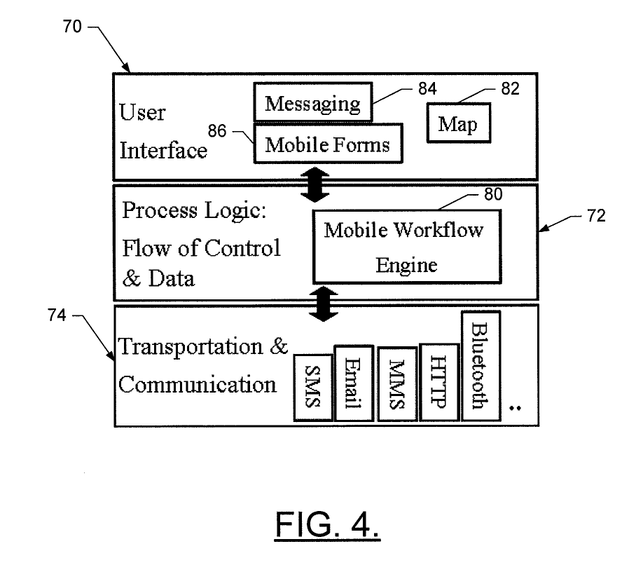

In an exemplary embodiment, at least one entity (e.g., the users 66 and 67, the advertiser 64 and the point of sale entity 68) of FIG. 3, and in some embodiments more than one entity or more than one entity in combination with another entity or entities, may include a device or means for providing (either separately or combined) user interaction and application integration including business and communication logic. In this regard, for example, the device or means may include or otherwise be embodied as a workflow engine (e.g., mobile workflow engine 80 of FIG. 4). The workflow engine may be enabled to define complete application logic using, for example, a set of instructions or web pages (e.g., standard HTML pages), which may define user interactions with application and business logic defined, for example, by a sub set of standard Web Services Business Process Execution Language (WSBPEL) documents. Packaged documents may then be deployed within the workflow engine.

As shown in FIG. 3, the advertiser 64 may create content such as an advertisement or ad at operation 100. The ad may be communicated to recipients such as the user 66 via any of numerous communication mechanisms (e.g., email, SMS, MMS, popup ad, etc.) at operation 102. The user 66 may receive the ad at operation 104 and view the ad at operation 106. In some instances, the user 66 may share the ad with other users (e.g., the different user 67) such as is shown at operation 108. Furthermore, in some cases, the different user 67 could be a source of an ad or content for the user 66. If desired, the user 66 may request a coupon associated with the ad at operation 110. The advertiser 64 may access the coupon at operation 112 and provide information to the user 66 at operation 114. After accessing the information at operation 116, the user 66 may view the coupon at operation 118. The user 66 may then elect to redeem the coupon at operation 120. As such, when a coupon is received, the user 66 may directly interact with the point of sale entity 68 to redeem the coupon. The point of sale entity 68 may receive the coupon at operation 122 and request verification from the advertiser 64 at operation 124. The advertiser 64 may verify the coupon at operation 126 so that the point of sale entity 68 may be enabled to provide the benefit associated with the coupon to the user 66 at operation 128. The user 66 may then receive the offer associated with the coupon at operation 130 and the point of sale entity 68 may notify the advertiser 64 at operation 132. The advertiser 64 may then receive the notification at operation 134.

FIG. 4 illustrates a layered architecture of processes and/or functions which may be performed by, for example, the respective devices associated with the advertiser 64, the users 66 and 67 and the point of sale entity 68. In this regard, FIG. 4 illustrates various layers and various applications, devices or means that may be configured to provide the processes and/or functions. For example, the architecture may include a user interface layer 70, a process logic layer 72 and a transportation and communication layer 74. As indicated above, in an exemplary embodiment, the architecture may be defined by a WS-BPEL document. The WS-BPEL document may provide declarative instructions to the workflow engine (e.g., the mobile workflow engine 80 of the process logic layer 72) on how the work flow engine may handle application specific user interaction, business logic and communication outside the respective device. The WS-BPEL document may also provide instructions for interaction with local applications such deployed in the respective device. The WS-BPEL document may also be used to define process oriented logic of a specific application that runs in a distributed manner from the mobile workflows engine 80.

In one exemplary embodiment, ActiveForms, which is an exemplary runtime for mobile application forms, may be used for designing ads as one example of a content creation mechanism. As such, according to this example, mobile process logic may be defined using WS-BPEL in order to enable a distributed viral advertising system. Application logic may be used to define roles carried out by the entities (e.g., the users 66 and 67, the advertiser 64 and the point of sale entity 68) involved in the system. User interaction and application logic may also be defined using, for example, standard web pages with corresponding processing within the respective workflow engines of the respective devices. The user interface for each respective device may be defined using, for example, HTML pages and process instructions may be encoded into WS-BPEL description documents.

Roles and the activities associated with each of the entities may be as follows. In this regard, for example, the respective device associated with each entity may include process logic (e.g., via the respective workflow engine of the device) and user interface logic to enable inter-device or inter-process communication as described below. For example, the advertiser 64 may be configured to enable ad or content creation. The advertiser 64 may also be enabled to send a created (or received) ad to a potential customer (e.g., the users 66 and/or 67). The advertiser 64 may also be configured to supply or provide a coupon to the user 66 in response to a request for the coupon. The advertiser 64 may also be enabled to provide information about the ad to the user 66 when the user 66 attempts to access such information. In some embodiments, the advertiser 64 may be further enabled to verify an issued coupon to the point of sale entity 68 and register information when a coupon has been redeemed at the point of sale entity 68 and notification of the redemption is received.

The user 66 and the point of sale entity 68 may also be configured to support activities associated with each of the operations described above in reference to FIG. 3. As such, as shown in FIG. 4, the user interface layer 70 may include various applications, instructions or modules for enabling the user to provide information to and/or receive information from the user of the device associated therewith. For example, the user interface layer 70 may include a map application 82 for receiving information on device location (e.g., via the positioning sensor 36) and/or providing information to a user of the device regarding location or location based services. The user interface layer 70 may also include a messaging application 84 for enabling messages to be provided to or received from a user of the device. The user interface layer 70 may also include a forms application (e.g., mobile forms application 86) for enabling the device to, for example, generate content or ads. As indicated above, the mobile workflow engine 70 may provide processing logic for enabling the flow of control and data to be managed. The transportation and communication layer 74 may include various communication applications (e.g., Bluetooth™, HTTP, MMS, email, SMS, etc.) by which messages, responses and/or content may be received from or transmitted to other devices.

As discussed above, rather than spamming or providing relatively indiscriminate mass messaging to a plurality of users, advertisers (or other content providers) may utilize an exemplary embodiment of the present invention in order to limit initial distribution to a set of individuals that may be more likely to thereafter ensure effective distribution of the material associated with the initial distribution. In other words, according to an exemplary embodiment, a particular user or users (e.g., the user 66) may be identified, based on information about the user or users, as having a relatively high potential for enabling (or initiating) viral distribution. As such, a user characteristic may be defined by which particular users may be considered to have a relatively high viral distribution potential. In this regard, for example, a user with a relatively high viral distribution potential may be selected from a group of users based on the activities of the user. In a specific example, a user that is active in sharing information with others in a social network, has a prominent position in a social or professional network, and/or has a relatively high rate of acceptance of, or action taken in response to, content that the user provides to other users may be considered to be an active node (e.g., a node with high viral distribution potential).

Accordingly, embodiments of the present invention may include a mechanism by which to identify particular users that may be considered to be an active node. Once an active node is identified, an ad or other content may be provided to the active node with the hope that the active node may provide or otherwise assist in an effort to achieve effective distribution of the ad or content. Furthermore, according to an exemplary embodiment, the social network of various active nodes may be mapped or otherwise determined in order to, for example, learn information about the active node and the members of the active node's social network so that, for example, a particular ad may be targeted to a particular audience.

Embodiments of the present invention may also enable the user 66 to directly query the point of sale entity 68 for coupon redemption. If a service platform or online portal is employed, access to the point of sale entity 68 may be provide via the service platform or online portal. As such, if the service platform or online portal provides interactions between the user 66 and the point of sale entity 68, privacy may be maintained between the user 66 and the point of sale entity.

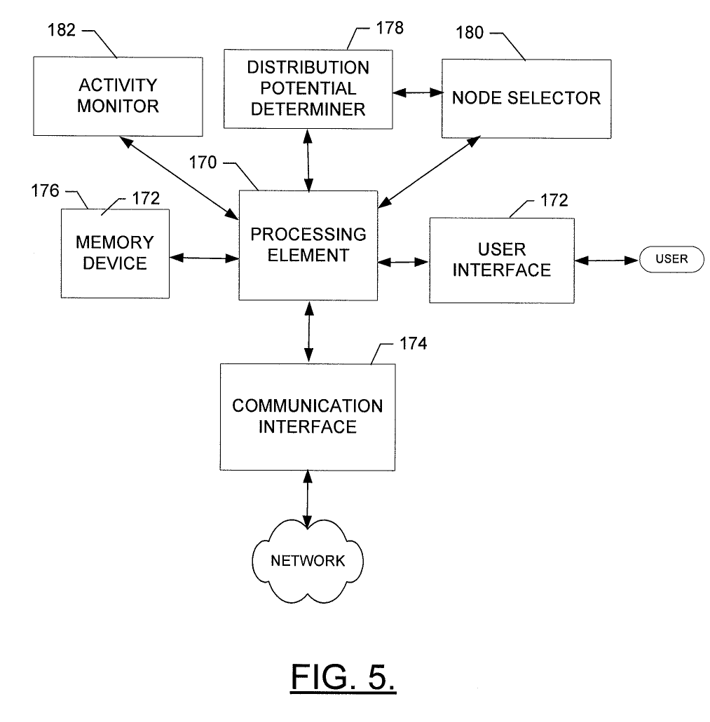

An exemplary embodiment of the invention will now be described with reference to FIG. 5, in which certain elements of an apparatus for enabling selection of an active node are displayed. The apparatus of FIG. 5 may be embodied as or otherwise employed, for example, on a network device such as a server of FIG. 2. However, it should be noted that the apparatus of FIG. 5 (or portions of the apparatus of FIG. 5), may also be employed on a variety of other devices, both mobile (e.g., the mobile terminal 10) and fixed, and therefore, embodiments of the present invention should not be limited to application on devices such as servers. It should also be noted that while FIG. 5 illustrates one example of a configuration of an apparatus for enabling active node selection, numerous other configurations may also be used to implement embodiments of the present invention.

Referring now to FIG. 5, an apparatus for enabling active node selection is provided. The apparatus may include or otherwise be in communication with a processing element 170, a user interface 172, a communication interface 174 and a memory device 176. The memory device 176 may include, for example, volatile and/or non-volatile memory (e.g., volatile memory 40 and/or non-volatile memory 42). The memory device 176 may be configured to store information, data, applications, instructions or the like for enabling the apparatus to carry out various functions in accordance with exemplary embodiments of the present invention. For example, the memory device 176 could be configured to buffer input data for processing by the processing element 170. Additionally or alternatively, the memory device 176 could be configured to store instructions for execution by the processing element 170. As yet another alternative, the memory device 176 may be one of a plurality of databases that store information in the form of static and/or dynamic information, for example, in association with a particular location, event or service point.

The processing element 170 may be embodied in a number of different ways. For example, the processing element 170 may be embodied as a processor, a coprocessor, a controller or various other processing means or devices including integrated circuits such as, for example, an ASIC (application specific integrated circuit) or FPGA (field programmable gate array). In an exemplary embodiment, the processing element 170 may be configured to execute instructions stored in the memory device 176 or otherwise accessible to the processing element 170. As such, for example, the processing element 170 may be embodied as, or otherwise control, the workflow engine (e.g., the mobile workflow engine 80). Meanwhile, the communication interface 174 may be embodied as any device or means embodied in either hardware, software, or a combination of hardware and software that is configured to receive and/or transmit data from/to a network and/or any other device or module in communication with the apparatus. In this regard, the communication interface 174 may include, for example, an antenna and supporting hardware and/or software for enabling communications with a wireless communication network.

The user interface 172 may be in communication with the processing element 170 to receive an indication of a user input at the user interface 172 and/or to provide an audible, visual, mechanical or other output to the user. As such, the user interface 172 may include, for example, a keyboard, a mouse, a joystick, a touch screen display, a conventional display, a microphone, a speaker, or other input/output mechanisms. In an exemplary embodiment in which the apparatus is embodied as a server, the user interface 172 may be limited, or even eliminated.

In an exemplary embodiment, the processing element 70 may be embodied as or otherwise control a distribution potential determiner 178 and a node selector 180. The distribution potential determiner 178 and the node selector 180 may each be any means or device embodied in hardware, software, or a combination of hardware and software that is configured to carry out the functions of the distribution potential determiner 178 and the node selector 180, respectively, as described herein. In this regard, for example, the distribution potential determiner 178 (which in an exemplary embodiment may be embodied at a server or other network device) may be configured to receive information associated with one or more users (e.g., devices (mobile or fixed) associated with particular users or potential customers or recipients of material) and determine a distribution potential of the user(s) based on characteristics of the user as determined by monitoring activity of the devices or terminals associated with the respective user(s). As such, for example, the distribution potential determiner 178 may be configured to receive information on device activity associated with a particular user. In some instances, the particular user may be associated with multiple devices (e.g., one or more mobile terminals, PCs, gaming platforms, or the like). As such, the distribution potential determiner 178 may be configured to determine distribution potential for each device of the user or for all devices in aggregate that may be associated with the user.

Thus, for example, individual device activity (e.g., mobile terminal 10 activity or activity of a PC of a particular user) and/or overall user activity may be used for determining distribution potential for the particular user and the distribution potential may be user based or device based. Accordingly, for example, if a particular user has certain activity patterns with respect to one device (e.g., the mobile terminal 10) that would indicate a high degree of activity (and therefore a higher distribution potential), but another device (e.g., the user's PC) is relatively inactive, the distribution potential of the mobile terminal 10 may be higher than that of the PC so that an advertiser (or other content distributor) may target the mobile terminal 10 of the particular user for initial distribution of content that is desired for further distribution by the particular user. Additionally or alternatively, particular types of content or activities associated with each respective device may be monitored so that if one device (e.g., the mobile terminal 10) is typically utilized for sharing a particular type of content (e.g., coupons) with others, while another type of content (e.g., music or other media) is typically utilized for sharing with others via another device (e.g., the PC), an advertiser may select the mobile terminal 10 for initial distribution of a coupon instead of selecting the PC.

Similarly, the information on the type of content distributed by a user may be utilized to give additional descriptive information that may be associated with the user's distribution potential (e.g., a content descriptor) to define the type of content that is typically distributed by the user. As such, the content descriptor may be additional information provided with the distribution potential. However, in an alternative embodiment, each user (or each device associated with a user) may receive a content related distribution potential rating or score. Thus, for example, a particular user may have a high distribution potential for certain types of content or genres (e.g., consumer ads) with a low distribution score for certain other types of content or genres (e.g., music).

Monitoring of activity may be performed by an activity monitor 182. The activity monitor 182 may be any means or device embodied in hardware, software, or a combination of hardware and software that is configured to carry out the functions of the activity monitor 182 as described herein. In some embodiments, the activity monitor 182 may be collocated with the distribution potential determiner 178 (e.g., part of the same apparatus). However, in alternative embodiments, the activity monitor 182 may be located in a separate device than the distribution potential determiner 178. In an exemplary embodiment, the distribution potential determiner 178 and the node selector 180 may be located at a network device (e.g., a server associated with or accessible to an advertiser (e.g., in a device associated with the advertiser 64)) while the activity monitor 182 may be located at either or both of the server associated with or accessible to the advertiser and a remote node (e.g., the mobile terminal 10 or PC associated with the user 66). If the activity monitor 182 is remotely located, information related to device activity may be communicated from the activity monitor 182 to the distribution potential determiner 178 by any suitable communication mechanism (e.g., via a wireless or wired communication network).

The activity monitor 182 may be configured to monitor device activity as described above. In this regard, for example, the activity monitor 182 may store information for communication or otherwise directly communicate the information to the distribution potential determiner 178 in which the information is indicative of the activities of the device being monitored. For example, the activity monitor 182 may be configured to record or otherwise report information such as identities of individuals or numbers to which communications were made and the nature of such communications (e.g., phone call, SMS, MMS, email, etc. for data forwarding, content sharing (including the type of content shared), message transmission, etc.) to the distribution potential determiner 178. Further information such as the time and/or length of a communication, data indicative of a relationship with a contact to which a communication was sent, data indicative of the response of the entity receiving the communication (e.g., coupon redeemed, item purchased, message erased with or without further action, content subsequently forwarded to others, etc.), and/or the like may also be communicated to the distribution potential determiner 178.

If the activity monitor 182 is located at a device associated with the user 66 (e.g., the mobile terminal 10 or PC of the user 66), the activity monitor 182 may collect data for communication to the distribution potential determiner 178 at various intervals or in response to queries from the distribution potential determiner 178. In an exemplary embodiment, the information collected by the activity monitor 182 may be information that is indicative of social networking attributes of the user 66 as well as other information indicative of whether the user 66 may be an effective distributor of received material. In this regard, for example, various context related information may be useful in determining whether a user will be an effective distributor of material. Accordingly, the activity monitor 182 may be configured to monitor information about a particular user's contacts, which may be obtained, for example, from a call register of the user's device or messaging logs, etc. Other context data such as time, location and activity can be extracted through various applications. The context data may be utilized in identifying active nodes as well as to identify possible relationships between two nodes. Context may therefore be useful since updated context may play a significant role in certain content distribution scenarios (e.g., ad marketing). Furthermore, context may imply which content may be relevant at a particular time.

In an exemplary embodiment, the activity monitor 182 may be configured to monitor various context attributes and sources for reporting to the distribution potential determiner 178. Some examples are provided below. In this regard, for example, a user's contacts may be monitored. Call register, address book, calendar information, tasks, alarm settings, call, message or other activity logs, may be monitored. Accordingly, information related to numbers, groups, or individual contacts called or from which a call or message has been received may be accessed. Information about device capabilities (e.g., external connectivity capabilities), personal profile information and/or settings preferred by the user may also be accessed and reported. Location information may also be reported (e.g., from the positioning sensor 36). Activity related statistics may also be monitored and reported such as call count and frequency (in aggregate or to particular contacts), call length, message frequency and count, web sites or addresses visited, downloads conducted, applications used, activated or enabled (e.g., games, media players, camera, radio, television, etc.), and/or the like. Other factors that may be reported, and therefore that may be used for determining distribution potential, may include networking potential, workflow involvement, mobile context, ad or content response, and parameters collected.

Networking potential may be indicated by, for example, the number of online community memberships associated with the user, job titles, lifestyle data, employer, the user's blogging frequency, web sites visited, content of personal websites, online affiliates, number of published articles, etc. Data indicative of networking potential may be collected from logs, mining blog aggregators, text processing, or inquiring of activities engaged in using a controlled environment such as an online portal or service platform. Workflow involvement may provide an understanding of the domain or role of the user (e.g., the node associated with the user) within a network that may be inherent in the workflow of the node. The contacts (number and characteristics of individual contacts) may be indicative of the node's role in workflow. In some instances, a particular node may have different or similar roles in a plurality of networks. For example, a node may have multiple professional networks (e.g., each associated with a particular case or project) and multiple social networks (e.g., familial, friend, or topic of interest based).

Commonalities in mobile context between otherwise remotely associated nodes may, in some cases, be treated as a strong relationship between the two nodes in order to suggest that both nodes could be active nodes. For example, nodes sharing common interests as indicated by subscriptions to certain mobile alerts, downloading certain content, having similar communication patterns, responding to surveys or contests using mobile devices, making frequent online purchases or bids using mobile devices, or the like may be considered to have a strong relationship to each other. Commonalities in geographic location or other demographic factors may also impact mobile context information that may be gathered and reported.

In some cases, the ad or content receipt response characteristics may also be monitored by the activity monitor 182 and reported to the distribution potential determiner 178. Such information may identify nodes that, for example, are effective for add distribution or forwarding based on the frequency at which such nodes forward and/or redeem ads. Statistical information related to the frequency at which a node ignores ads, requests coupons in response to ad receipt, or forwards such ads to others may be indicative of ad response characteristics. Further information related to the number of contacts to whom items such as content or ads are forwarded and the corresponding number of such forwarded items that receive a positive response may also be reported. Other relevant information that may be reported may include device/user ID, advertisement and/or advertiser ID, point of sale ID, action carried out (e.g., read, deleted, ignored, forwarded, redeemed, etc.), action context (e.g., location, time, channel (e.g., Bluetooth/MMS, etc.).

In response to receipt of the information provided by the activity monitor 182, the distribution potential determiner 178 may be configured to determine the distribution potential of the respective user or device of the user (e.g., of a particular node). In an exemplary embodiment, the distribution potential determiner 178 may be configured to determine a rating or score for each user or device. The rating or score may be indicative of the respective user or device's potential for further distribution of content (or of particular content). In other words, the rating or score defines the distribution potential of the respective user. Since viral distribution may be a positive potential outcome, the score could be considered to be a viral distribution potential rating. In any case, the distribution potential of a user may be indicative of the user's potential for further distribution and/or potential for effective further distribution (e.g., distribution that is likely to be well received by the recipients of the distribution).

In an exemplary embodiment, the distribution potential determiner 178 may be configured to analyze any or all of the factors described above that may be monitored and reported by the activity monitor 182 in order to determine a distribution potential for a node. In some embodiments, a plurality or even each node in a system may be analyzed and assigned a corresponding distribution potential by the distribution potential determiner 178. In order to determine the distribution potential of a particular node, the distribution potential determiner 178 may, for example, utilize an algorithm that weighs various factors (e.g., as indicated by the reports from activity monitor 182) and determines a distribution potential score based on the weighted factors. Some factors may be assigned different weights corresponding to respective different types of content or ads. In an exemplary embodiment, the distribution potential determiner 178 may be configured to consider the weighting of each factor in determining an overall score for a particular node.

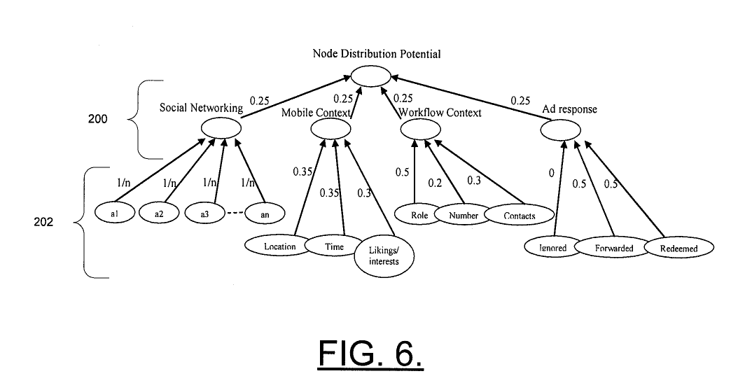

FIG. 6 illustrates an example of a criteria tree for use in active node selection according to an exemplary embodiment. In this regard, as shown in FIG. 6, weighting factors may be assigned to each of various attributes 200 forming constituent factors for determining the overall (or ad/content based) distribution potential for the corresponding node. Each of the attributes 200 may additionally have one or more individual parameters 202 that combine to provide a score associated with each attribute that may then be weighted (e.g., in a manner determined by the content to be distributed or in a fixed or predetermined manner) to determine the distribution potential. Other methods may alternatively be used instead of or in addition to the criteria tree of FIG. 6 for distribution potential determinations by the distribution potential determiner 178. The distribution potential determiner 178 may then communicate distribution potential determinations to the node selector 180 to enable the node selector 180 to determine whether a particular node may be selected as an active node (e.g., a node with sufficient distribution potential to be indicative of a likely candidate for initiating effective distribution of content).

In the exemplary embodiment shown in FIG. 5, the activity monitor 182, the node selector 180 and the distribution potential determiner 178 are shown as being separate entities. However, the activity monitor 182, the node selector 180 and the distribution potential determiner 178 could be embodied as or in the same device in some instances (or may each be embodied as the processing element 170). For example, all of the activity monitor 182, the node selector 180 and the distribution potential determiner 178 could be embodied at a single mobile terminal or at a single PC, server or other network device. Alternatively, one or more of the activity monitor 182, the node selector 180 and the distribution potential determiner 178 may be split between separate devices.

In an exemplary embodiment, the node selector 180 may be configured to determine whether the distribution potential for a given node is suggestive of the given node being an active node. In some cases, the node selector 180 may be configured to compare the distribution potential (or score) determined by the distribution potential determiner 178 to a threshold for active node determinations. As such, for example, the node selector 180 may determine whether a particular node has a distribution potential above a threshold amount. If the distribution threshold is above a threshold amount (or below dependent upon the scoring paradigm used), the node selector 180 may select the particular node as an active node.

In an exemplary embodiment, the node selector 180 may be configured to employ a multi-attribute utility theory (MAUT) algorithm for active node selection. A typical active node may be considered to have a high distribution potential in terms of the effectiveness of the node for distribution of ads or content in a viral network. Considering the nodal characteristics mentioned above (e.g., the parameters monitored by the activity monitor 182), active node selection may be seen as a multiple criteria determination. The MAUT algorithm may be one way to approach a problem of selecting active nodes from a given set of nodes that each have multiple attributes.

MAUT is an exemplary decision making method that may be used when it is desirable to consider multiple attributes (or requirements) before selecting a candidate of interest. MAUT allows rating the attributes involved and performance of computations using a utility function which may be used to depict the desirability of the attributes. Accordingly, the overall utility of a node, e.g., to be selected on the basis of the attributes listed above, may be provided by the following function:

$$U ( X ) = {\sum }_{i = 1}^{n} {w}_{i} * {u}_{i} ( {x}_{i} ) with {\sum }_{1}^{n} {w}_{i} = 1 \qquad ( 1 )$$

where, xᵢ is the ith attribute with weight wᵢ and uᵢ(xᵢ) is the utility function on the ith attribute. U(X), which may serve as the distribution potential score of a node may be determined on a node by node basis. An analytic hierarchy process may be used to arrive at the distribution potential score. This approach may aid in selection of a candidate which satisfies certain criteria, on the basis of a set of alternatives. The criteria can be expanded further into sub-criteria and so on, hence forming a hierarchical criteria tree (e.g., as shown in FIG. 6). A leaf criterion (e.g., parameters 202) may typically be the specification of a desired property that the candidate may have and parent criteria (e.g., attributes 200) may be more abstract criteria that cannot necessarily be represented by a single parameter. The criteria may be prioritized to distinguish between crucial criteria and accessory criteria by virtue of changing weights, so that a node's selection can be attributed more to its satisfying of an important criterion than that of a less relevant criterion. The MAUT equation (1) may be used to rate the candidate nodes. In an exemplary embodiment, the utility function for each leaf criteria under every parent criterion may be computed as:

$$u ( {x}_{i} ) = \frac{{x}_{i}}{{MAX}_{i}} \qquad ( 2 )$$

where MAXᵢ=max└xₖ, . . . xⱼ┘ where xₖ, . . . xⱼ are all the leaf attributes under the parent criterion.

In some embodiments, computing a score for a leaf attribute may be as simple as providing a score of 1 for the leaf if the associated parameter or criterion is present and providing a score of 0 otherwise. However, other scoring mechanisms may be employed such as providing a scaled score at each level within the hierarchy of the criteria tree. Furthermore, additional levels may be added to the hierarchy, if desired.

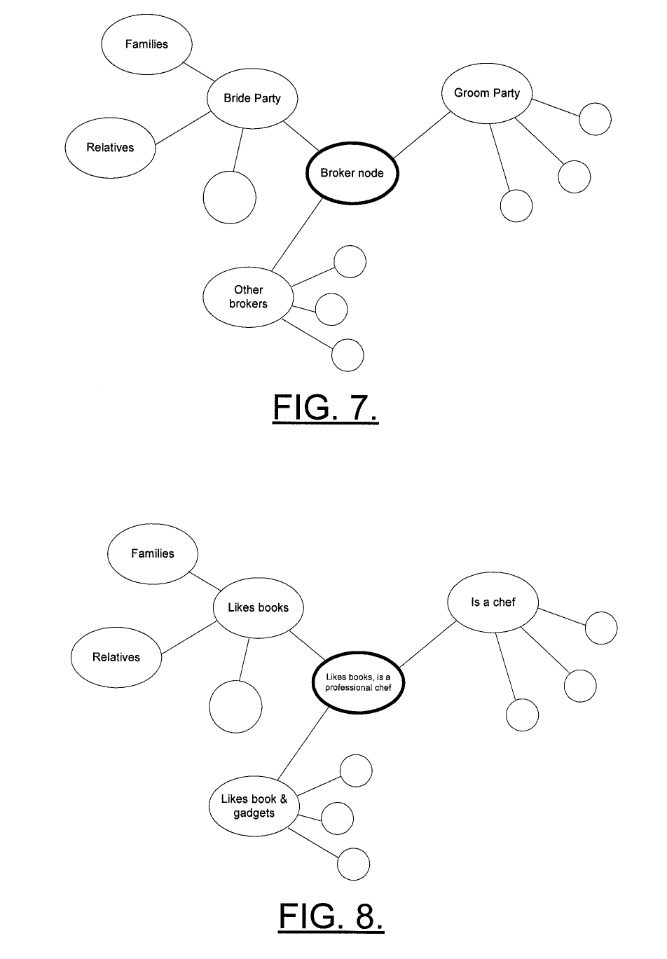

As indicated above, it may be desirable in some instances to consider a particular user's (e.g., as indicated by the activity of a respective node) characteristics with respect to a particular type of content to be distributed, a likelihood that content forwarded by the user will be received positively, the user's role in social networks associated with the user and/or the user's relationship to other users. Accordingly, in some embodiments, it may be beneficial to visualize the user's network relationships in consideration of specific factors. Although the consideration of these factors may be handled by the algorithm described above, some embodiments may also find it useful to map out relationships on the basis of certain factors as described below. In this regard, the distribution potential determiner 178 may be further configured to construct or otherwise perform calculations and/or determinations that may approximate the relationships and/or data provided by the exemplary viral network visualizations of FIGS. 7-10.

In this regard, FIG. 7 illustrates a network based on workflow roles for a particular node (e.g., a broker node) that may be evaluated by the distribution potential determiner 178. As shown in FIG. 7, the broker node may have relationships with different brokers and parties associated with an event (e.g., a wedding). Each relationship may lead to other relationships thereby defining a potential distribution path for materials that may be supplied to the broker node for distribution. Using the information of FIG. 7, it may be possible for an advertiser to determine whether the broker node is likely to reach a desired audience with particular material. If the particular material is associated with the context of the broker node's activities (e.g., wedding flowers, tailoring services, DJ services), such information may be of particular significance.

FIG. 8 illustrates an exemplary network based on similar interests among various contexts (e.g., as may be determined from mobile context information). Among other things, similar interests may include similar profession, similar download activities, similar purchasing activities, etc. Using the information of FIG. 8, it may be possible for an advertiser to determine whether a particular node is likely to reach a desired audience with particular material. If the particular material is associated with the similar interests of the nodes illustrated, a likelihood of distribution and utilization of the distributed material may be enhanced.

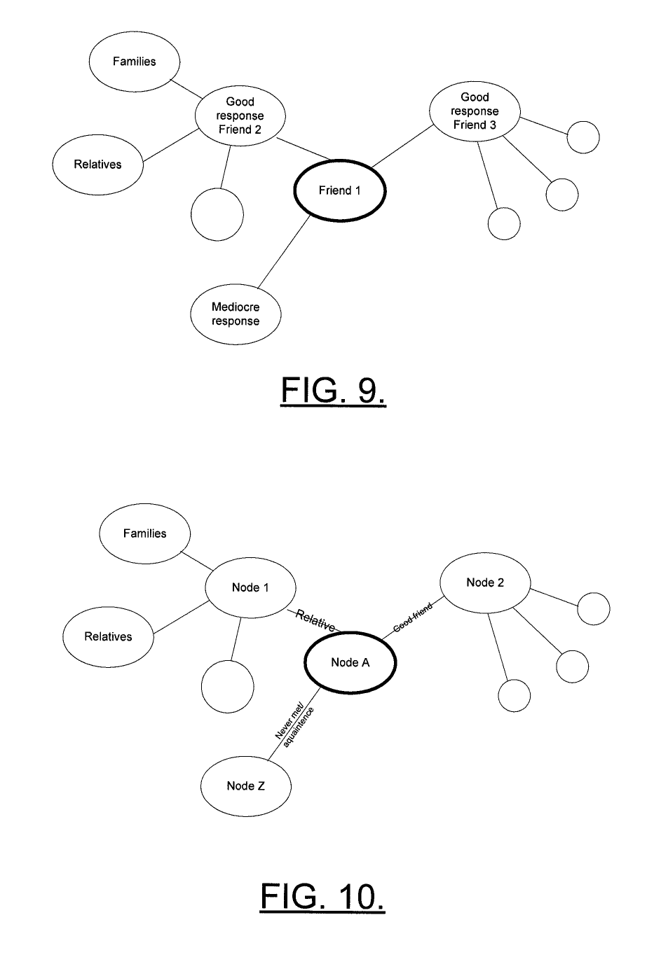

FIG. 9 illustrates an exemplary network based on positive responses received from nodes to which a particular node (e.g., Friend 1) sent messages or forwarded ads. Using the information of FIG. 9, it may be possible for an advertiser to determine whether a particular node is effective in distributing material regardless of how much material the node distributes. In this regard, for example, it may be possible to determine whether the particular node is a trusted, respected or well received provider of information or recommendations or whether the particular node is habitually ignored by receivers of information sent by the particular node.

FIG. 10 illustrates an exemplary network based on relationships between nodes. Among other things, relationships like family bonds, friendship bonds, acquaintance relationships, etc., may be provided by such an illustration. Using the information of FIG. 10, it may be possible for an advertiser to determine whether a particular node is likely to reach a desired audience with particular material. Thus, networks like the one shown in FIG. 10 may be analyzed for selection of a targeted audience.

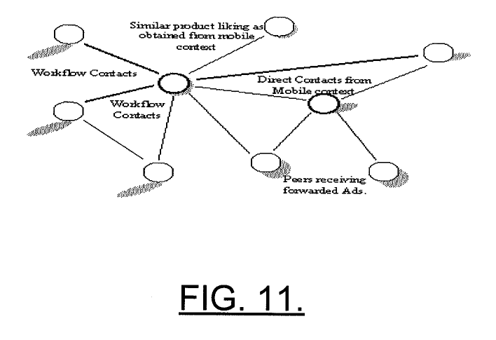

Thus, consideration of relationships between nodes may be included when determining whether to select a particular node as an active node. Such considerations may be made in addition to a distribution potential score or may actually be factored into the distribution potential score of a particular node. Other factors for consideration in identifying relationships between nodes may include mobile context, location information, shared workflow contacts, etc. FIG. 11 illustrates an example of a relatively comprehensive diagram of a network illustrating different factors that may influence relationships between nodes.

Based on the information above, for example, the apparatus of FIG. 5 may be configured to determine a distribution potential for a particular node based on characteristics of the particular node (e.g., via the distribution potential determiner 178). The distribution potential may be indicative of a relative likelihood of the particular node distributing content received by the particular node. The apparatus may also be configured to select the particular node as an active node in response to a determination that the distribution potential meets predetermined selection criteria (e.g., via the node selector 180). In an exemplary embodiment, the social network of an active node and the strength and/or character of relationships the active node has may be analyzed or visualized for use in targeting a particular audience for specific content (or ads). Additionally, based on monitored activity of the active node and/or the nodes the active node is likely to communicate with, personalized content or advertisements may be provided. For example, content related to specific services, games, video, audio, coupons, broadcasts, or goods that may be more likely to be accepted or purchased may be provided for distribution by the active node. In some instances, the personalization may be in part based on profile information of various users, user device content scanning, user location, presence information, etc. In an exemplary embodiment, an advertiser or content provider may be able to show specific ads or content in an ad enabled application using, for example, widgets/widsets or a viral distribution channel for ads or content.

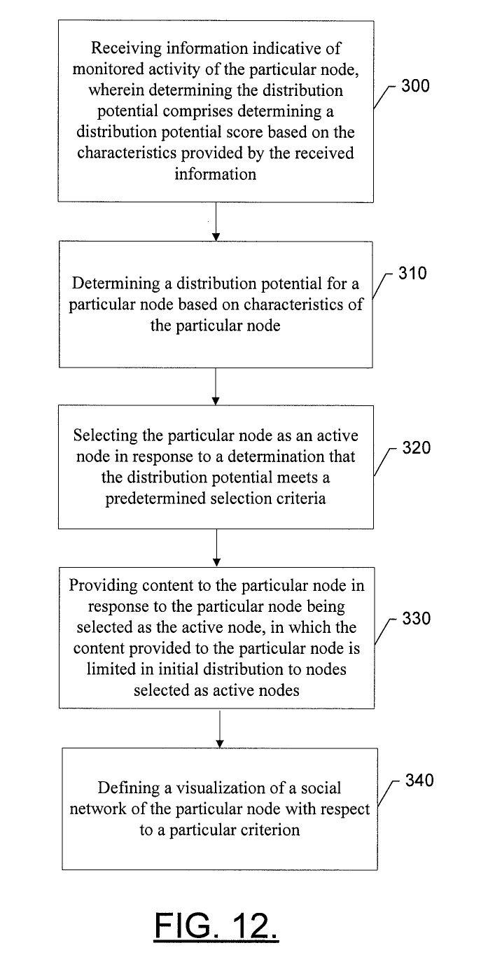

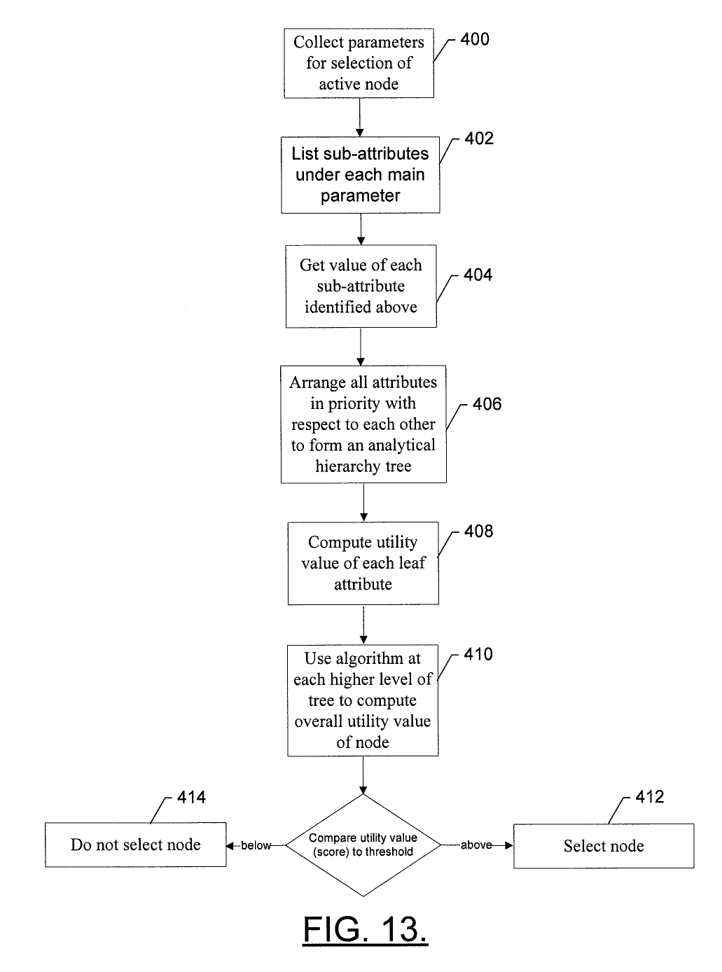

FIGS. 12 and 13 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or server and executed by a built-in processor in the mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for enabling active node selection as provided in FIG. 12 may include determining a distribution potential for a particular node based on characteristics of the particular node at operation 310, and selecting the particular node as an active node in response to a determination that the distribution potential meets a predetermined selection criteria at operation 320. The distribution potential may be indicative of a relative likelihood of the particular node distributing content received by the particular node.

In an optional embodiment, the method may further include an initial operation of receiving information indicative of monitored activity of the particular node. However, in some embodiments the information may be provided in the same device where the determining and selecting are performed and thus there is no need for initial receipt of the information (or the information may be received via internal device communications). In some cases, determining the distribution potential may include determining a distribution potential score based on the characteristics provided by the received information. In embodiments where information indicative of monitoring activity is provided, the information may be permissively provided from a monitoring device or agent within a mobile terminal or other device of a user or potential customer. In some alternative embodiments where a service platform or online portal provides services, the monitoring may be provided by the service platform or online portal. As indicated above, when monitoring is provided by the service platform or online portal, privacy may be maintained. Furthermore, in some embodiments, rather than selecting an active node merely at the node level, the service platform or online portal may further enable determination of an active network or group. Thus, for example, rather than targeting only a particular node, an entire city, social network or group may be defined as being active for the purposes of some embodiments of the present invention.

In another optional embodiment, the method may further include providing content to the particular node in response to the particular node being selected as the active node at operation 330. In such an embodiment, the content provided to the particular node may be limited in initial distribution to nodes selected as active nodes. In an exemplary embodiment, determining the distribution potential for the particular node may include, for example, determining a content specific distribution potential for the particular node based on monitored activities of the particular node related to particular content or utilizing a weighted consideration of a plurality of attributes related to activity or characteristics of the particular node. One example of a mechanism determining the distribution potential for the particular node may include utilizing a multi-attribute utility theory algorithm for determining the distribution potential of the particular node.

In an optional exemplary embodiment, the method may further include defining a visualization of a social network of the particular node with respect to a particular criterion at operation 340. In such an embodiment, selecting the particular node as an active node in response to a determination that the distribution potential meets the predetermined selection criteria may include, for example, utilizing the visualization of the social network to determine a distribution potential score with respect to the particular criterion. In such an embodiment, determining the distribution potential score with respect to the particular criterion may include, for example, enabling selection of the particular node at least in part based on a desired target audience being associated with the particular node as defined by relationship data comprising the particular criterion or enabling selection of the particular node at least in part based on a likelihood of receiving a positive response to data forwarded from the particular node as defined by response data comprising the particular criterion. In some embodiments, a particular node may further be selected based at least in part on a likelihood that the particular node is likely to forward received data.

As shown in FIG. 13, an exemplary method for selection of an active node may include the collection of parameters for selection of an active node at operation 400. At operation 402, a list of sub-attributes under each main parameter may be provided. A value may be determined for each sub-attribute identified in operation 402 at operation 404. The method may further include arranging all the attributes in priority with respect to each other to form an analytical hierarchy tree (e.g., as in FIG. 6) at operation 406. A utility value of each leaf attribute may be calculated (e.g., using equation (2) above) at operation 408. At operation 410, an algorithm may be used at each higher level of the tree to compute an overall utility value or distribution probability score for the node (e.g., using equation (1) above). If the score is above a threshold, the node may be selected as an active node and relationships with other nodes may be analyzed at operation 412. Meanwhile, if the score is not above the threshold, the node may not be selected at operation 414.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining a distribution potential for a particular node based on characteristics of the particular node, the distribution potential being indicative of a relative likelihood of the particular node distributing content received by the particular node; and
selecting the particular node as an active node in response to a determination that the distribution potential meets predetermined selection criteria.

2. The method of claim 1, further comprising an initial operation of receiving information indicative of monitored activity of the particular node, wherein determining the distribution potential comprises determining a distribution potential score based on the characteristics provided by the received information.

3. The method of claim 1, further comprising providing content to the particular node in response to the particular node being selected as the active node, in which the content provided to the particular node is limited in initial distribution to nodes selected as active nodes.

4. The method of claim 1, wherein determining the distribution potential for the particular node comprises determining a content specific distribution potential for the particular node based on monitored activities of the particular node related to particular content.

5. A computer program product comprising at least one computer-readable storage medium having computer-readable program code portions stored therein, the computer-readable program code portions comprising:
a first executable portion for determining a distribution potential for a particular node based on characteristics of the particular node, the distribution potential being indicative of a relative likelihood of the particular node distributing content received by the particular node; and
a second executable portion for selecting the particular node as an active node in response to a determination that the distribution potential meets a predetermined selection criteria.

6. The computer program product of claim 5, further comprising a third executable portion for an initial operation of receiving information indicative of monitored activity of the particular node, wherein the first executable portion includes instructions for determining a distribution potential score based on the characteristics provided by the received information.

7. The computer program product of claim 5, further comprising a third executable portion for providing content to the particular node in response to the particular node being selected as the active node, in which the content provided to the particular node is limited in initial distribution to nodes selected as active nodes.

8. The computer program product of claim 5, wherein the first executable portion includes instructions for determining a content specific distribution potential for the particular node based on monitored activities of the particular node related to particular content.

9. The computer program product of claim 5, wherein the first executable portion includes instructions for enabling selection of the particular node at least in part based on a likelihood of the particular node communicating received content to other nodes.

10. An apparatus comprising:
a distribution potential determiner configured to determine a distribution potential for a particular node based on characteristics of the particular node, the distribution potential being indicative of a relative likelihood of the particular node distributing content received by the particular node; and
a node selector configured to select the particular node as an active node in response to a determination that the distribution potential meets a predetermined selection criteria.

11. The apparatus of claim 10, wherein the distribution potential determiner is configured to initially receive information indicative of monitored activity of the particular node, wherein determining the distribution potential comprises determining a distribution potential score based on the characteristics provided by the received information.

12. The apparatus of claim 10, wherein the apparatus is configured to provide content to the particular node in response to the particular node being selected as the active node, in which the content provided to the particular node is limited in initial distribution to nodes selected as active nodes.

13. The apparatus of claim 10, wherein the distribution potential determiner is configured to determine a content specific distribution potential for the particular node based on monitored activities of the particular node related to particular content.

14. The apparatus of claim 10, wherein the distribution potential determiner is configured to utilize a weighted consideration of a plurality of attributes related to activity or characteristics of the particular node.

15. The apparatus of claim 10, wherein the distribution potential determiner is configured to utilize a multi-attribute utility theory algorithm for determining the distribution potential of the particular node.

16. The apparatus of claim 10, wherein the distribution potential determiner is configured to define a visualization of a social network of the particular node with respect to a particular criterion.

17. The apparatus of claim 16, wherein the node selector is configured to utilize the visualization of the social network to determine a distribution potential score with respect to the particular criterion.

18. The apparatus of claim 17, wherein the node selector is configured to enable selection of the particular node at least in part based on a desired target audience being associated with the particular node as defined by relationship data comprising the particular criterion.

19. The apparatus of claim 17, wherein the node selector is configured to enable selection of the particular node at least in part based on a likelihood of receiving a positive response to data forwarded from the particular node as defined by response data comprising the particular criterion.

20. The apparatus of claim 10, wherein the node selector is configured to enable selection of the particular node at least in part based on a likelihood of the particular node communicating received content to other nodes.
